(19) United States
(12) Patent Application Publication
(10) Pub. No.: US 2011/0020098 A1
(43) Pub. Date: Jan. 27, 2011

(54) STORAGE RACK WITH LOADING MANAGEMENT

(76) Inventor: Bernd Pfaffmann, Speyer (DE)

Correspondence Address: EDELL, SHAPIRO & FINNAN, LLC, 1901 RESEARCH BOULEVARD, SUITE 400, ROCKVILLE, MD, 20850, US

(21) Appl. No.: 12/739,743

(22) PCT Filed: Sep. 2, 2008
(86) PCT No.: PCT/EP2008/007162

§ 371 Date: Sep. 7, 2010

(30) Foreign Application Priority Data
Oct. 26, 2007 (DE) 10 2007 051 653.5

(51) Int. Cl. B65G 1/06; B65G 1/04

(52) U.S. Cl. 414/274; 414/807

(57) ABSTRACT

The invention relates to a method of introducing article carriers (4) in a storage facility (1), wherein an article carrier (4), during introduction, is received by a conveying apparatus (2) and transported to a storage location (3). The invention also relates to a stationary conveying apparatus (2) for a storage facility (1), in particular for a storage rack (1), having at least one accommodating means (3, 11, 2) for an article carrier (4), and it further relates to a storage facility (1), in particular a storage rack (1), having at least one storage location (3), at least one introduction region (9) connected to the storage location (3), and at least one conveying apparatus (2) which can be moved back and forth between the storage location (3) and the introduction region (9). In order to improve the method of introducing article carriers (4) into a storage facility (1), and to improve the corresponding storage facility (1) together with conveying apparatus (2), and to avoid any risk resulting from overloading of the article carriers (4), storage facility (1) or conveying apparatus (2), it is provided according to the invention that the conveying apparatus (2) detects a weight (G, g) of the article carrier (4).

The invention relates to a method for introducing article carriers into a storage facility, wherein an article carrier, during introduction, is received by a conveying device and transported to a storage location. The invention also relates to a stationary conveying device for a storage facility, in particular for a storage rack, having at least one receiving organ for an article carrier, and it further relates to a storage facility, in particular a storage rack, having at least one storage location, at least one introduction region connected to the storage location, and at least one conveying device which can be moved back and forth between the storage location and the introduction region.

Storage facilities in the form of storage racks with conveying devices of the aforementioned type and corresponding methods for introducing article carriers into and withdrawing them from these storage facilities are known. For the better exploitation of storage areas the storage facilities mostly have a plurality of storage locations arranged in them on top of each other and next to each other, into which article carriers carrying articles can be introduced. The article carriers are positioned, for example, in an introduction region upstream of or in a loading and withdrawal opening so as to be moved by a receiving organ or a transfer device onto a conveying device to allow the conveying device to convey the article carrier to a determined storage location. This storage location can be chosen, for example, by a user who transferred the article carrier to the storage facility, or the storage facility determines a storage location for the article carrier by itself on the basis of available data about the article carrier and the articles stored on it. If the stored article carrier is needed by a user, it will be transported by the conveying device from its storage location to the introduction region, where it can be withdrawn from the storage facility.

A storage facility comprising a conveying device which is designed as a storage elevator is known, for example, from DE 101 15 765 A1. A storage elevator withdraws an article carrier in the form of a tray from a transfer position from a loading and withdrawal opening of a storage rack and subsequently transports the article carrier to the storage location provided for it.

The prior storage facilities, conveying devices as well as the methods known for introducing and withdrawing article carriers have the drawback that both the conveying devices and the storage facilities as well as the storage locations arranged in the same can be overloaded. If an article carrier is loaded too heavily, for example, its high weight can result in the inability of the conveying device to transport the article carrier up to its storage location and in the conveying device possibly suffering a defect on its way to the storage location, with the consequence that it stops. Also, there is the risk that sections of the storage facility are loaded too heavily if a plurality of very heavily loaded article carriers are arranged in them. Thus, there is the risk of a defect of or damage to mobile parts of the storage facility. Moreover, it is possible that the user is put into danger if malfunctions arise from possible static or dynamic overloads of the storage facility.

Therefore, the invention is based on the object to improve an aforementioned method for introducing article carriers into a storage facility and the corresponding storage facility including the conveying device, and to avoid any possible danger resulting from excessively loading the article carriers, the storage facility or the conveying device.

In a method according to the invention this object is achieved by the conveying device determining a weight of the article carrier. This simple solution has the advantage that the weight of the article is known after the determination and that it can be decided on the basis of the weight how to proceed with the article carrier.

This inventive solution can be optionally combined and further improved with the following method steps, which are each advantageous as such:

According to a first possible advantageous improvement of an inventive method it may be provided that the conveying device determines the weight of the article carrier prior to the transport to the storage location. This allows the consideration of the weight data of the article carrier already before the conveying device transfers the article carrier to a storage location. This is particularly advantageous if, according to another possible improvement of an inventive method, it is provided that the storage location is chosen in response to the determined weight. For example, certain storage locations could be suited to accommodate great weights, while other storage locations could be rather not suited therefor. Also, the weights accommodated by the storage facility can be distributed in a better way, so that there will be no concentration of very heavily loaded article carriers in individual areas of the storage facility.

According to another possible improvement of an inventive method it may be provided that the conveying device does not introduce the article carrier if the determined weight thereof exceeds a predetermined limit weight. This limit weight can be obtained, for example, from the admissible total weight or transport weight of the conveying device, or from the admissible loading weight of a storage location or the storage facility. If the article carrier is not introduced because a limit value is exceeded, the aforementioned dangers resulting from the exceeded limit value are avoided.

According to another possible improvement of an inventive method the article carrier can be transferred from a transfer position to the conveying device. The weight of the article carrier can then be determined, for example, during this transfer. However, the weight of the article carrier can also already be determined in the introduction region itself, or only when the article carrier is positioned on the conveying device in a ready-to-load state. If the latter case applies, a reaction to an overloaded article carrier according to another possible improvement of an inventive method may be that the article carrier is returned to the transfer position if the determined weight thereof exceeds a predetermined limit weight.

According to another possible advantageous improvement of an inventive method the weight determination may be differentiated by determining a total weight of the article carrier from a sum of subweights. This may be an advantage in particular if, according to another possible improvement of an inventive method, it is provided that a loading ratio for the article carrier is calculated from the ratios of the subweights of the article carrier and the conveying device does not introduce the article carrier if the loading ratio thereof is greater and/or smaller than a predetermined limit ratio. It would be possible, for example, that the articles are concentrated in a certain section of the storage area of the article carrier, which is therefore loaded in a very one-sided manner. This one-sided and unbalanced loading of the article carrier can entail the damage thereof as well as a malfunction and wrong loading of the conveying device and the storage facility.

According to the proposed solution to the aforementioned object and the aforementioned improvements of an inventive method the determined weight of an article carrier can, in general, be its total weight or a subweight of the article carrier, with its total weight being obtained from the sum of its subweights.

With respect to the aforementioned conveying device the above object is achieved in that the conveying device has at least one weighing means which can generate a signal representative of a weight of the article carrier. Thus, the conveying device itself can determine the weight and the subweights of the article carrier. Based on the weight information a suitable algorithm available to the conveying device may be used to decide how to proceed with the article carrier in response to its weight.

Especially if the storage facility has a plurality of introduction regions it may be provided according to a first possible improved embodiment of an inventive conveying device that the weighing means is arranged in a mobile manner. Thus, only one central weighing means has to be provided, which weighs the article carriers to be picked up at different introduction regions. The weighing means may perform a double function if, according to another possible advantageous embodiment of an inventive conveying device, it is provided that a horizontal guiding organ and/or a vertical drive element of the weighing means is embodied as a weighing organ which can generate a signal representative of the weight of the article carrier. The weighing means can thereby transport the article carrier itself. The horizontal guiding organ or the vertical drive element of the weighing means, thus, fulfill a double function in the form of an element which simultaneously carries and drives and weighs the weighing means.

According to another possible embodiment an inventive conveying device can be improved in that an axle receiving at least partially the weight of the weighing means is embodied as weighing element which can generate a signal representative of the weight of the weighing means. Thus, it is possible to permanently determine the total weight or the subweights of the weighing means, wherein the weight of an article carrier stored on the weighing means is obtained from the difference of the unloaded and the loaded weighing means.

According to another possible embodiment of an inventive conveying device the weight measurement can be realized particularly easily if a sensor is arranged on and/or in the axle which can generate a signal representative of the deflection of the axle. As the weight of the article carrier and the weighing means is carried on the axle, the deflection thereof represents the weight of the weighing means and the article carrier. Thus, by designing the axle as weighing element, the total part of the conveying device carried on the corresponding axle can be understood as weighing means, and its weight as well as the weight of an article carrier carried on the conveying means can be determined in a particularly elegant manner.

With respect to the aforementioned storage facility the above-mentioned object is achieved in that the storage facility comprises a conveying device which is designed according to the preceding embodiments. Thus, the storage facility can determine the weight of article carriers to be introduced into same by itself and prevent the transport and introduction of an overloaded article carrier. The storage facility may simultaneously transmit possible information about the weight of the article carrier to be introduced to a user, or also about the residual weight which the storage facility or the article carrier are still able to receive. To this end, the storage facility can indicate, e.g. by means of a suitable interface, how many free capacities it still has or how much, possibly subdivided weight it may still receive.

Below, the invention will be explained in more detail by means of examples on the basis of advantageous embodiments with reference to the drawings. The embodiments described merely represent possible embodiments in which, as was described above, the individual features can be realized independently of each other or omitted, however.

In the drawings:

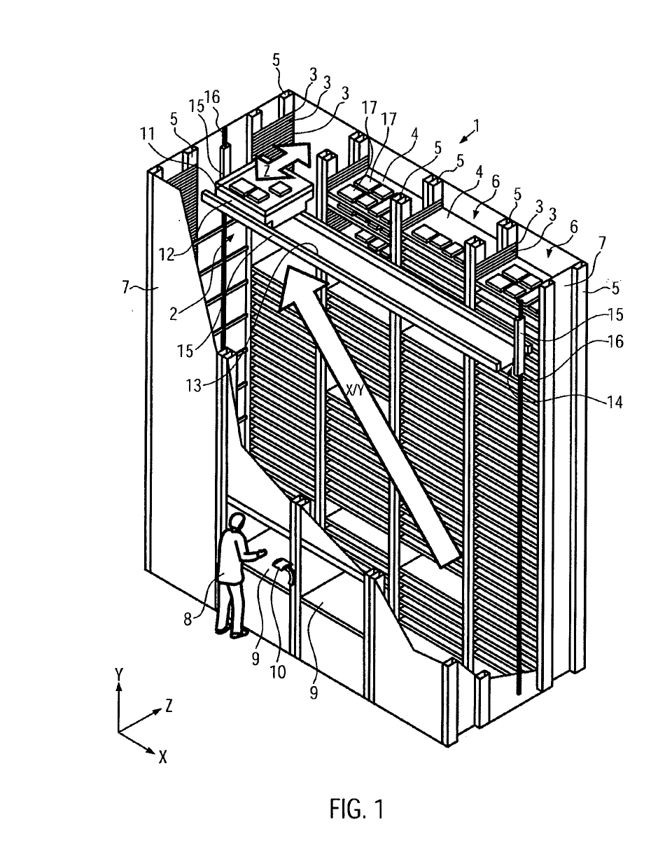

FIG. 1 shows a schematic perspective view of an inventive storage facility comprising an inventive conveying device;

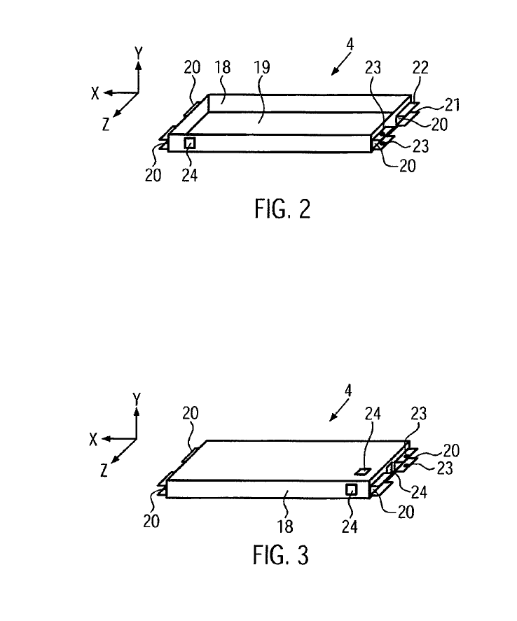

FIG. 2 shows a schematic perspective view of an article carrier;

FIG. 3 shows a schematic perspective view of the bottom side of the article carrier of FIG. 2;

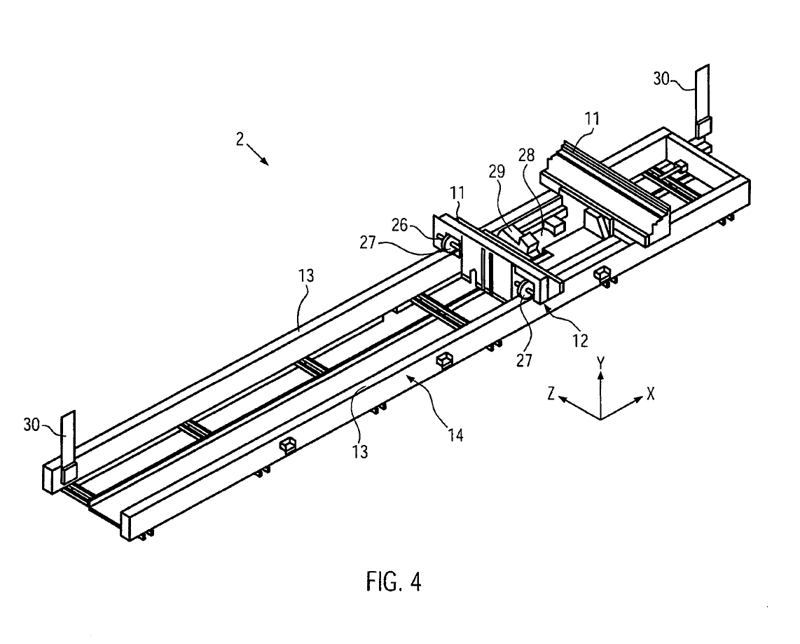

FIG. 4 shows a schematic perspective view of a vertical and a horizontal conveying device of a conveying device according to the invention;

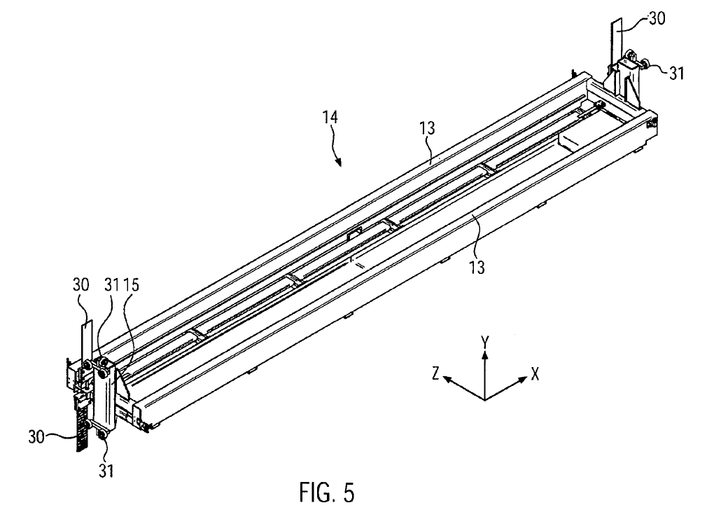

FIG. 5 shows a schematic perspective view of the vertical conveying device of FIG. 4;

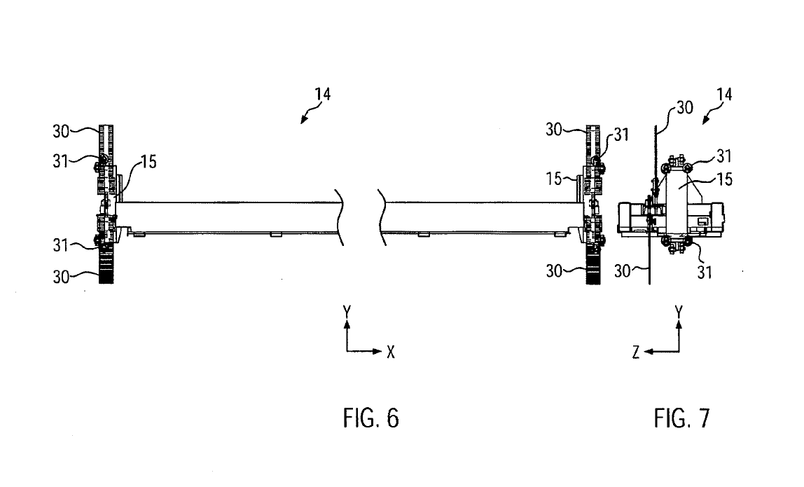

FIG. 6 shows a schematic front view of the vertical conveying device of FIG. 5;

FIG. 7 shows a schematic lateral view of the vertical conveying device of FIGS. 5 and 6;

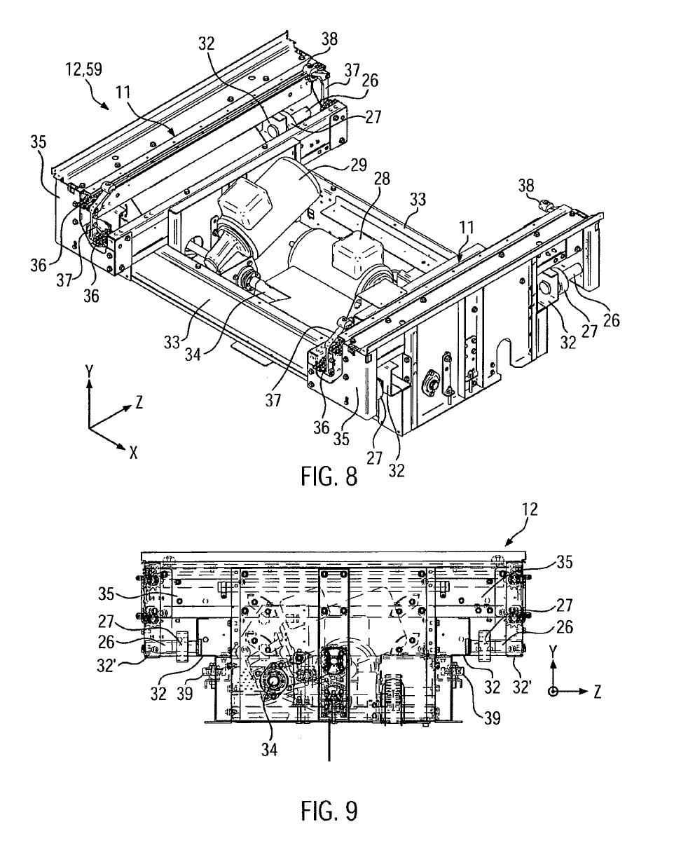

FIG. 8 shows a schematic perspective view of an inventive horizontal conveying device of an inventive conveying device;

FIG. 9 a schematic lateral view of the inventive horizontal conveying device of FIG. 8;

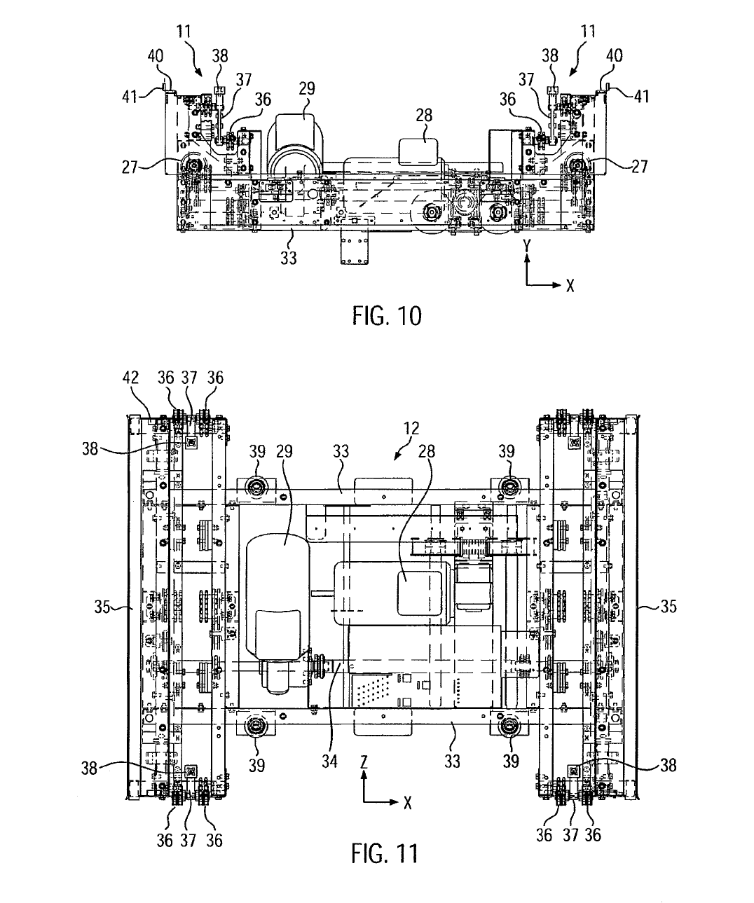

FIG. 10 a schematic front view of the inventive conveying device of FIGS. 8 and 9;

FIG. 11 a schematic top view of the inventive horizontal conveying device of FIGS. 8 to 10;

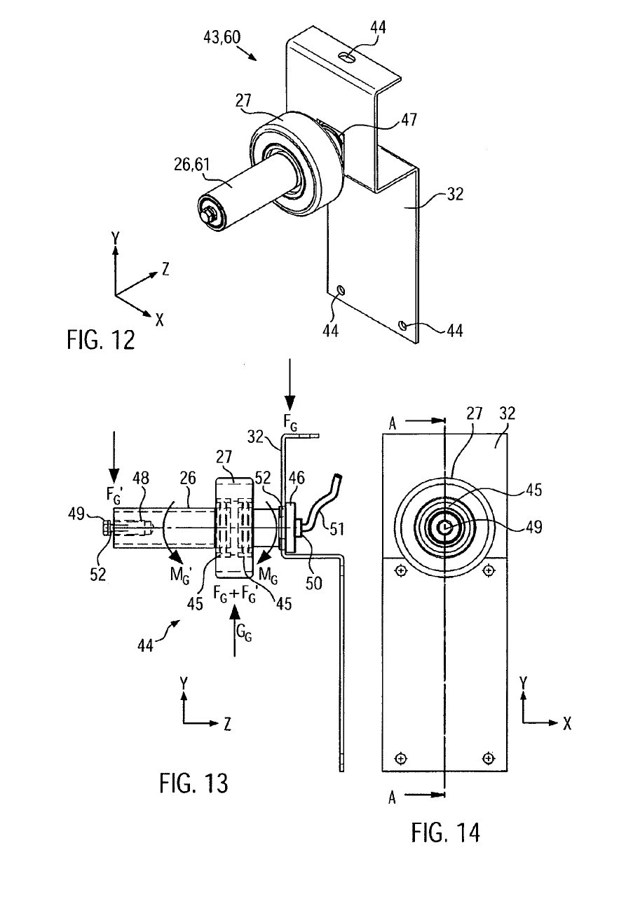

FIG. 12 a schematic perspective view of an inventive horizontal guiding organ formed of a wheel suspension, an axle and a roller;

FIG. 13 a schematic lateral view of the inventive horizontal guiding organ of FIG. 12;

FIG. 14 a schematic front view of the inventive horizontal guiding organ of FIGS. 12 and 13;

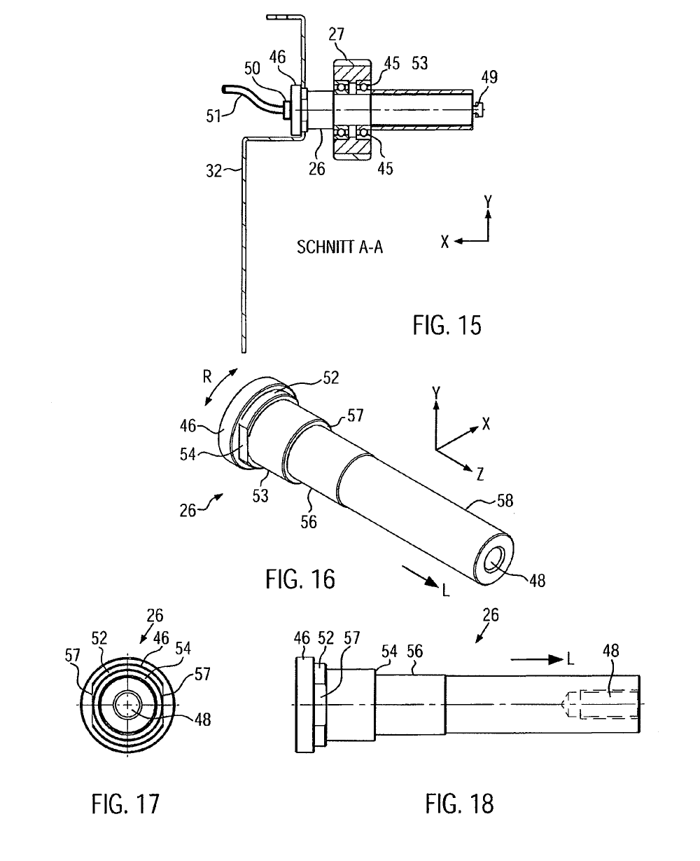

FIG. 15 a schematic sectional view of the inventive horizontal guiding organ of FIGS. 12 to 14 along the intersection line A-A in FIG. 14;

FIG. 16 a schematic perspective view of a roller axle inventively designed as weighing element;

FIG. 17 a schematic front view of the roller axle of FIG. 16;

FIG. 18 a schematic lateral view of the roller axle of FIGS. 16 to 17.

Initially, an embodiment of an inventive storage facility 1 will be described by means of FIG. 1, which shows the storage facility 1 equipped with an inventive conveying device 2 in a schematic perspective view. The storage facility 1 has a plurality of storage locations 3, which are predefined by horizontal support profiles 3. Article carriers 4 in the form of trays 4 are introduced into the storage locations 3. The storage locations 3 are fixed to vertical supports 5. Four vertical supports 5 form one rack column 6 of the storage facility 1. Moreover, wall elements 7 are fixed to the outside of the storage facility 1, which encase the storage facility 1 and protect the interior thereof against harmful environmental impacts and, at the same time, prevent a user 8 from entering a danger zone in the storage facility.

The user 8 withdraws the article carriers 4 from and loads them into the storage facility 1 at introduction regions 9 in the form of loading and withdrawal openings 9 of the storage facility 1. For the purpose of requesting or introducing an article carrier 4 the user 8 can communicate with the storage facility 1 via an interface 10. The interface 10 can be, for example, a computer terminal or also a data interface such as an infrared, radio or near radio interface. The user 8 may be a person or also an automatically or manually operated transport vehicle.

According to need, the article carriers 4 are conveyed by the conveying device 2 back and forth between the loading and withdrawal openings 9 and the corresponding storage locations 3.

The conveying device 2 comprises a transfer device 11, which can move an article carrier 4 in a transverse direction Z so as to withdraw it from the loading and withdrawal opening 9 or from a storage location 3 or deposit it there. The transfer device 11 is, in this case, arranged on a horizontal conveying device 12, which is movable in a horizontal direction X so as to move back and forth between the storage locations 3 or the rack columns 6, respectively, and the loading and withdrawal openings 9 in the horizontal direction X on a horizontal guide 13. The horizontal guide 13 for the horizontal conveying device 12 is, in turn, arranged on a vertical conveying device 14. The vertical conveying device 14 is substantially formed of a lifting beam 15 defining the horizontal guide 13 and a vertical guide 16 receiving the lifting beam 15 on a vertical guiding organ 15.

As is schematically shown in FIG. 1, the conveying device 2 can move an article carrier 4 stored on it simultaneously in the horizontal direction X and in the vertical direction Y through the storage facility 1, so that the article carrier 4 takes a diagonal, shortest possible way through the storage facility 1 if it is moved back and forth between the storage locations 3 and the loading and withdrawal openings 9.

On the article carriers 4 articles 17 are stored, the orientation and numbers of which as well as the dimensions and weights of which vary. However, the total weight G or a subweight g of the article carrier 4 must not exceed an admissible limit weight Gₘₐₓ or limit subweight gₘₐₓ so as to ensure a safe operation of the storage facility 1. These limit weights Gₘₐₓ, gₘₐₓ result from the fact that, for example, the article carriers 4, the storage locations 3, the rack columns 6 and their vertical supports 5 and/or the conveying device 2 as well as the components thereof, and finally the article carriers themselves have a load limit, up to which their function both under a static and a dynamic viewpoint can be ensured. That is, as of a specific limit weight Gₘₐₓ or limit subweight gₘₐₓ the article carriers 4 can no longer be moved with sufficient safety by the motors (not yet shown herein) or power transmission means (not yet shown herein) driving the conveying device, or the storage locations 3, the rack columns 6 and the vertical supports 5 can no longer receive the sum of the weights of article carriers stored on them with sufficient safety. Accordingly, it is desirable to be able to perform weight measurements at the article carriers 4 before or as they are transported to their storage locations 3.

In order to allow a better demonstration of an inventive weight determination at the article carriers, additional technical features and details of the components of the inventive storage facility 1 will be explained first by means of FIGS. 2 to 18 described below. For the sake of simplicity like features will be provided with like reference numbers so as to avoid repetitions in the specification and to preserve a consistency of the herein used reference numbers.

FIG. 2 shows a schematic perspective view of an article carrier 4. The article carrier 4 comprises a storage area 19 surrounded by an edge 18. Supporting webs 20 are laterally fixed to the edge 18 of the article carrier 4, which substantially extend in the transverse direction Z provided for introducing and transferring the article carrier 4. The supporting webs 20 have two legs 21, 22, which are spaced apart from each other in the vertical direction Y and extend in the horizontal direction X.

Push-out protections 23 in the form of bores or recesses 23 are provided on the legs 21, 22. These push-out protections 23 can be engaged from behind by a suited gripping element or locking means (herein not yet shown) on a transfer device so that the article carriers 4 can be transferred safely and are not unintentionally displaced.

Moreover, a data carrier 24 facing in the transverse direction Z is fixed to the outside edge 18 of the storage area 19. Information about articles 17 stored on the article carrier 4 may be stored on the data carrier 24. These information can include, for example, the type of articles stored, their order and part numbers or also possible time limits, e.g. delivery dates, use-by dates or best-before dates. According to the invention these information may also include details about the type and nature of the goods stored, e.g. their weight, dimensions such as, in particular, the storage height, and possible storage requirements such as the admissible total weight or the measured weight of the article carrier.

The data carrier 24 may be a radio frequency identification chip (RF-id) 24 or another data carrier 24, e.g. an infrared chip, a Bluetooth chip or also a data carrier to be configured optically such as an infrared chip or a simple bar code. Such a data carrier 24 can, for example, also be capable of communicating with the interface 10 at the storage facility 1 or an interface 10′ at the conveying device 2.

FIG. 3 shows the article carrier 4 of FIG. 2 upside down, so that a bottom side 25 of the article carrier 4 faces upwardly. Here, it becomes apparent that a data carrier 24 may also be fixed to the bottom side 25 or to an outer wall 18 of the article carrier 4 facing in the horizontal direction X. On the outer wall 18 of the article carrier 4 the data carrier 24 can also be arranged, for example, between two supporting webs 20. Data carriers 24 fixed to both the side wall or the edge 18 of the article carrier in the transverse direction Z or the horizontal direction X and the bottom side 25 thereof may also fulfill an additional function as positioning aid when the article carrier is transferred.

It is not imperatively required that the supporting webs 20 be fixed in a double, sub-divided form to the outer wall 18 of the article carrier 4 facing in the horizontal direction X, but it offers the possibility to mount a data carrier 24 between the webs 20 or to simply save material for the supporting webs 20. The supporting webs 20 can be fixed to the article carrier 4 by means of a positive connection, e.g. by means of rivets or screws, but may also be formed integrally from the material of the article carrier 4.

FIG. 4 shows a schematic perspective view of a portion of the conveying device 2 illustrated in FIG. 1. It shows the horizontal conveying device 12 with horizontal guiding organ in the form of wheels 27 mounted on axles 26, which are arranged as horizontal guide elements 27 to be movable in the horizontal direction X on the horizontal guides 13 of the vertical conveying device 14. To this end, the horizontal conveying device 12 is driven by a drive unit 28 which can drive, for example, the wheels or rollers 27 or moves the horizontal conveying device 12 by means of corresponding driving aids mounted on the horizontal conveying device 12 and the horizontal guide 13. In addition, the horizontal conveying device 12 has a second drive unit 28 for operating the transfer device 11, by means of which the article carriers 4 are transferred in the transverse direction Z onto the horizontal conveying device 12, that is, are loaded onto or withdrawn from it.

Moreover, vertical drive elements 30 in the form of belts 30 are mounted on the vertical conveying device 14, on which the vertical conveying device 14 can be moved by its vertical guiding organ 15 along the vertical guide 16. Likewise, the vertical drive elements 30 could also be mounted on the vertical conveying device 14 in the form of motors, so that it can drive itself in the vertical direction Y.

FIG. 5 shows a schematic perspective view of the vertical conveying device 14 shown in FIG. 4 without the horizontal conveying device 12 placed on top of it. This figure particularly illustrates the arrangement of the vertical drive elements 30 and the vertical guiding organ 15. These engage with vertical guide elements 31 in the form of vertical guide elements 31 arranged in a rectangular in the form of vertical guide rollers 31 into the vertical guide 16 on the storage facility 1 and permit that the vertical conveying device 14 is guided through the storage facility 1 precisely in the vertical direction Y.

FIG. 6 and FIG. 7 each show the vertical conveying device 14 in a schematic front and lateral view. Again, the arrangement of the vertical drive elements 30 substantially extending in the vertical direction Y as well as the vertical orientation of the vertical guiding organ 15 with the vertical guide elements 31 mounted on them can be clearly recognized.

FIG. 8 shows a schematic perspective view of an inventive horizontal conveying device 12. Axles 26 for the wheels 27 are mounted on wheel suspensions 32 in the form of metal sheets 32. Between two transverse beams 33 the drive units 28, 29 are mounted. The drive unit 29 is connected by a transmission element 34 in the form of a shaft to a transverse driving device 36 in the form of chain drives 36 of the transfer device 11, said transverse driving device 36 each being arranged on two connection brackets 35. By means of the transverse driving device 36 gripping units 37 of the transfer device 11 are driven. The gripping units 37 comprise gripping elements 38 projecting in the vertical direction Y, which can engage, for example, with the supporting webs 20, legs 21, 22 and/or push-out protections 23 of the article carriers 4 so as to move the article carriers 4 in the transverse direction Z, that is, so as to lift them onto the horizontal conveying device 2 or unload them from it. If an article carrier 4 does not have corresponding devices such as supporting webs 20, legs 21, 22 or push-out protections 23 it would also be possible, for example, that the transfer device 11 simply lifts the article carrier 4 directly, for example, on its bottom side 25 so as to load it.

Thus, the transfer device 11 can move the article carrier 4 in the most different ways from a transfer position U into a loading position L, whereby the article carrier 4 is not carried on the transfer device 11 or the conveying device 2 in the transfer position U and is loaded onto the conveying device 2 in the loading position L.

FIG. 9 shows a schematic lateral view of the horizontal conveying device 12. The axles 26 are mounted between the wheel suspensions 32 and an axle receptacle 32′ of the horizontal conveying device 12. The wheels 27 project from underneath the connection brackets 35 so that they can move on the horizontal guides 13 of the vertical conveying device 14, by which the horizontal conveying device 12 is movable in the horizontal direction X. Additionally, the horizontal conveying device 12 comprises lateral horizontal guide elements 39 in the form of rollers 39 oriented axially, substantially in the vertical direction Y, which rollers 39 are laterally adjacent to the horizontal conveying device so as to guide the horizontal conveying device 12 precisely in the horizontal direction X.

FIG. 10 and FIG. 11 show the horizontal conveying device 12 illustrated in FIGS. 8 and 9 in a schematic front view and a schematic top view.

In FIG. 10 it can particularly be seen how the gripping elements 38 at the gripping units 37 project from the transfer device 11 in the vertical direction Y and, in the vertical direction Y, are approximately in one plane with deposit members 40 in the form of profiles 40. On the deposit members 40 an article carrier 4 can be deposited in the loading position L. At the same time, transfer guides 41 in the form of legs 41 projecting from the deposit members 40 in the vertical direction Y cause an article carrier 4 to be guided precisely into the loading position L or the transfer position U during the transfer onto or from the horizontal conveying device 12, for example, in order to prevent it from tilting.

FIG. 11 illustrates how the gripping elements 37 with the transverse driving device 36 are arranged to allow the gripping elements 38 to operate beyond the edges 42, which face in the transverse direction Z, of the connection brackets 35 of the horizontal conveying device 12 such that they can pick up and deposit an article carrier 4 next to the horizontal conveying device.

Moreover, it can be seen in FIG. 11 how the lateral horizontal guide elements 39 project from the transverse beams 33 in the transverse direction Z and are arranged in a rectangular so as to enable them to guide the horizontal conveying device 12 precisely in the horizontal direction X.

FIG. 12 shows a schematic perspective view of an inventive horizontal guiding organ 43 which is formed of the wheel suspensions 32, the axles 26 and the horizontal guide elements or rollers 27, respectively. The horizontal guiding organ 43 can be fixed to the horizontal conveying device 12 by means of fixing aids 44, by fixing the horizontal guiding organ 43, for example, by means of screws (not shown) inserted through the fixing aids 44 embodied as holes, or by means of any other positive, non-positive or adhesively joined connecting elements and techniques.

FIG. 13 shows a schematic lateral view of the horizontal guiding organ 43 shown in FIG. 12. It is outlined that the roller 27 is fixed to the axle 26 by bearings 45 in the form of ball bearings 45. On one side the axle 26 includes a flange 46 whose cross section is larger than that of the other regions of the axle. Thus, the axle 26 can be inserted into an axle receptacle 47 of the wheel suspension 32, wherein the internal radius of the axle receptacle 47 is substantially larger than the external radius of the axle 26 and smaller than the external radius of the flange 46. Thus, the flange is adjacent to a support surface of the wheel suspension 32, the support surface facing in the transverse direction Z, and contributes to the fixing of the axle 26 on one side in the transverse direction Z. For fixing the axle 26 completely, it is provided with a threaded bore 48 at the end facing away from the flange 46. A screw 49 as fixing means is inserted into the threaded bore 48, by means of which the axle can be fixed to axle receptacles 32′ of the horizontal conveying device 12.

At the end of the axle 26 where the flange 46 is located a sensor 50 projects out of the axle 26. The sensor 50 comprises a sensor connection 51 in the form of a cable 51. It is possible, however, to provide any other form of electrical connection, e.g. a plug-type connector or other coupling possibilities, for supplying the sensor 50 with power and for transmitting its sensor signals to an evaluation unit (not shown).

The sensor 50 is capable of detecting a deflection of the axle 26. The deflection of the axle 26 results from its loading in the vertical direction Y. Weights F_{G}, F′_{G} acting on the axle 26 result in bending moments M_{G}, M′_{G} in the regions of the axle 26 between the horizontal guide device 27 and the bearings 45 and pivot points 52 thereof, respectively.

By means of the sensor 50, which is embedded in the axle 26 and is provided in the form of a strain gauge assembly, these bending moments M_{G}, M′_{G} can be detected and an electrical signal representative of same can be transmitted through the cable 51 to an evaluation unit (not shown).

As the horizontal conveying device 12 is mounted on four rollers or horizontal guide elements 27 of the type as shown in FIGS. 12 to 15, which can particularly be seen in FIGS. 8 to 11, it is possible to determine on the basis of the bending moments M_{G}, M′_{G}, which can be determined by the respective sensors 50 in the axles 26, the weights F_{G}+F′_{G}=F_{A} carried on the axles as the axle weights acting in the respective axle.

From the bending moments M_{G}, M′_{G} in each axle results a total deflection of the axle representing the total subweight g_{g} of the horizontal conveying device 12 acting on the axle 26. The sum of the total subweights g_{g} received in the four axles 26 of the horizontal conveying device 12 results in the total weight G_{g} of the horizontal conveying device.

FIG. 14 shows a schematic front view of the horizontal guiding organ or axle suspension 43, respectively, of FIG. 13, with an intersection line A-A being drawn in. FIG. 15 shows a schematic sectional view of the horizontal guiding organ 43 illustrated in FIGS. 12 to 14 along the intersection line A-A of FIG. 14.

The axle 26 receives the rollers 27 on the bearings 45, and is itself received in a spacer sleeve 53. The spacer sleeve 53 helps in keeping the rollers 27 including the bearings 45 spaced apart from the axle receptacle 32′ of the horizontal conveying device 12.

FIG. 16 shows a schematic perspective view of an inventive axle 46. It can particularly be seen that the axle 26 has different radii defining different sections of the axle. That is, the axle has its largest radius at the flange 46, by means of which it is supported on the wheel suspension 32 in the transverse direction Z. Offset from the flange is the bearing point 52, by means of which the axle receives forces of the wheel suspension 32 acting the vertical direction Y. This shoulder 52 is provided with a flattened portion 54. The flattened portion 54 may serve to stop the axle during the operation and assembly by means of a gripping device gripping the axle 26 at the flattened portion 54, or by mounting the axle 26 in a receptacle in the wheel suspension 32, the receptacle having a shape complementary to the shape of the shoulder 52, in such a way that the axle cannot rotate in a direction of rotation R of the horizontal guide element and, consequently, maintains its provided spatial orientation.

This may facilitate a possible calibration and an operation of the sensor 50 received in the axle 26. The axle 26 and, thus, the sensor 50 arranged in the same is then always deflected in substantially the same direction, and the sensitivity and the measuring range of the sensor 50 in said orientation are then relevant for a sensor signal representing the subweight g_{g} of the horizontal conveying device 12 carried on the axle 26, including any possible loading.

The shoulder 52 is joined by a distance region 55 whose width measured in the longitudinal direction L_{A} of the axle determines the distance of the horizontal guide element 27 towards the wheel suspension 32. The bending moment M_{G} acting in this distance region 55 when the axle 26 is loaded may represent a measured quantity for the subweight g_{g} of the horizontal conveying device 12 carried on the axle 26.

The distance region 55 is joined by a bearing region 56 in the longitudinal direction L. From the distance region 55 the axle tapers towards the bearing region 56, so that here too a shoulder 57 is formed. The shoulder 57 can receive forces acting on the axle 26 in the axial direction L_{A} or transverse direction Z, respectively. Thus, the shoulder 57 serves to support the bearings 45 of the horizontal guide element 27 in the transverse direction Z.

The bearing region 56 is joined by a second distance region 58, which is slightly tapered over the bearing region 56 and which serves to receive the spacer sleeve 53 shown in FIG. 15. Thus, the bearings 45 of the horizontal guide element 27 can be fixed between the shoulder 57 and the spacer sleeve 53 on both sides in the transverse direction Z.

FIGS. 17 and 18 show the schematic front view and schematic lateral view of the axle shown in FIG. 16. It particularly illustrates the stepped tapering of the axle 26, which results in the formation of the flange 46, the bearing points 52 and the flattened portion 54, which form the distance region 55, the bearing region 56, the shoulder on the bearing region 57 and the second distance region 58.

In the embodiment of an inventive conveying device 2 illustrated in the above-described drawings the total weight G or subweights g of an article carrier 4 can be determined as the measured total weight G_{g} and the total subweight g_{g} of the horizontal conveying device 2 less the dead weight G_{F} and dead subweight g_{F} thereof. The weight G and the subweight g of the article carrier 4 thus result from the difference between the total weight G_{g} and the total subweight g_{g} of the horizontal conveying device 12 and the total dead weight G_{F} and dead subweight g_{F} thereof.

If an article carrier 4 is arranged by a user 8 in the transfer position U in the introduction region 9 of the storage facility 1, the conveying device 2 loads the article carrier 4 by means of the transfer device 11 into the loading position L onto the horizontal conveying device 12. By means of the sensors 50 disposed in the axles 26 of the horizontal conveying device 12 the subweight g exerted by the article carrier 4 onto each axle can now be determined, and thus its total weight G. That is, the horizontal conveying device 12 acts as a weighing means 59 for determining the subweights g of the article carrier 4 as well as the total weight G of the article carrier 4 resulting from the sum of the subweights g. The wheel suspensions 43 of the horizontal conveying device 12 consequently act as weighing organs 60 for determining the subweights g of the article carrier 4. In the weighing organs 60 in the form of the axle suspensions 43 the axles 26 are embodied as weighing elements 61 because they accommodate the sensors 50 by means of which a signal can be outputted which is representative of the total subweight g_{g} of the horizontal conveying device 12 and the weighing means 59 carried on the respective axle 26.

If a total weight G or a subweight g of an article carrier 4 is measured by the weighing means 59, which weight exceeds an admissible limit weight Gₘₐₓ or limit subweight gₘₐₓ, the conveying device 2 moves the article carrier 4 out of the loading position L back into the transfer position U and refuses the introduction of the article carrier 4 for the above-mentioned reasons. The fact that a limit weight Gₘₐₓ or a limit subweight gₘₐₓ are exceed can be indicated to the user 8 by the interface 10 which, to this end, may have corresponding display and data output means. If a limit subweight gₘₐₓ is exceeded while the limit weight Gₘₐₓ representative of the article carrier 4 as a whole is observed, the article carrier 4 is loaded incorrectly, which means that different regions of the storage area 19 of the article carrier 4 are loaded differently.

Such incorrect loadings may cause problems because they may result in a one-sided loading or, respectively, in an overloading of the conveying device 2 and the storage locations 3 limited to different elements, e.g. the axle suspensions 43. Consequently, these elements can be subject to a particularly strong wear because the corresponding elements of the conveying device 2 can get distorted under the incorrect loading, can be deformed or, in the case of their dynamical use, blocked, tilted or may run hot. If it is indicated to the user 8 that the limit subweight gₘₐₓ is exceeded, he can provide for a balance by distributing the loads of the articles 17 on the article carrier 4 more uniformly and take steps that the subweights g thereof are lower than the admissible limit subweight gₘₐₓ. At the same time, this entails that a loading ratio B, which can be calculated from the subweights, does not exceed an admissible limit loading ratio Bₘₐₓ.

However, if it is indicated to the user 8 that the limit weight Gₘₐₓ of the article carrier 4 as a whole is exceeded, he has the possibility to remove articles 17 from the article carrier 4 so as to reach a weight lower than the limit weight Gₘₐₓ and to allow the article carrier 4 to be conveyed by the conveying device 2 to the storage location 3 intended for it.

Modifications of the above-described embodiments within the scope of the inventive idea are possible. In a method according to the invention it is important that at least the total weight G of an article carrier 4, or also simply of an article 17 can be determined, so as to be able to prevent a conveying device 2 or a storage facility 1 or a storage location 3 arranged in the latter from being overloaded. It is not obligatory to use an article carrier 4. The articles 4 may also be received and conveyed directly.

There are a number of possibilities to embody parts of an inventive conveying device 2 and an inventive storage facility 1 as weighing means 59 with weighing organs 60 and weighing elements 61. It would be possible, for example, to provide the vertical drive elements 30 of the conveying device 2 with weighing organs 60 and weighing elements 61, so that the vertical conveying device 14 can be employed as a weighing means 59. Also, it would be possible to arrange sensors 50 in drive units 28, 29 or transmission elements 34 for driving the horizontal conveying device 2, the vertical conveying device 14 or the transfer device 11 in such a way that they are capable as weighing elements 61 of outputting a signal representative of a weight F_{G}, F′_{G} by assisting in the measurement of bending moments or torsions in the elements in question. Also an energy quantity consumed by an electric drive element 28, 29 and a variation of the voltage or current with time may supply information about the weight loading of an inventive conveying device 2 and correspondingly point to the weight G of an article carrier 4.

Beside the strain gauge assemblies used herein as sensors 50 any suitable measuring means based on inductive, capacitive, resistive, optical, piezoelectric or other measuring principles may be employed to determine a weight, a force or a moment or a deflection or spatial displacement.

1. Method for introducing article carriers (4) into a storage facility (1), wherein an article carrier (4), during introduction, is received by a conveying device (2) and transported to a storage location (3), characterized in that the conveying device (2) determines a weight (G, g) of the article carrier (4).

2. Method according to claim 1, characterized in that the conveying device (2) determines the weight (G, g) of the article carrier (4) prior to the transport to the storage location (3).

3. Method according to claim 1 or 2, characterized in that the storage location (3) is chosen in response to the determined weight (G, g).

4. Method according to one of the preceding claims, characterized in that the conveying device (2) does not introduce the article carrier (4) if the determined weight (G, g) thereof exceeds a predetermined limit weight (Gₘₐₓ, gₘₐₓ).

5. Method according to one of the preceding claims, characterized in that the article carrier (4) is transferred from a transfer position (U) onto the conveying device (2).

6. Method according to claim 5, characterized in that the article carrier (4) is returned to the transfer position (U) if the determined weight thereof exceeds a predetermined limit weight (Gₘₐₓ, gₘₐₓ).

7. Method according to one of the preceding claims, characterized in that a total weight (G) of the article carrier (4) is determined from a sum of subweights (g).

8. Method according to claim 7, characterized in that a loading ratio (B) for the article carrier (4) is calculated from the ratios of the subweights (g) of the article carrier (4) and that the conveying device (2) does not introduce the article carrier (4) if the loading ratio (B) thereof is greater and/or smaller than a predetermined limit loading ratio (Bₘₐₓ).

9. Stationary conveying device (2) for a storage facility (1), in particular for a storage rack (1), having at least one receiving organ (3, 11, 2) for an article carrier (4), characterized in that the conveying device (2) has at least one weighing means (5) which can generate a signal representative of a weight (G, g) of the article carrier (4).

10. Conveying device (2) according to claim 9, characterized in that the weighing means (59, 12) is arranged in a mobile manner.

11. Conveying device (2) according to claim 10, characterized in that a horizontal guiding organ (43) and/or a vertical drive element (30) of the weighing means (12, 59) is embodied as a weighing organ (60) which can generate a signal representative of the weight (G, g) of the article carrier (4).

12. Conveying device (2) according to claim 11, characterized in that an axle (26) of the weighing means (12, 59) receiving at least partially the weight (G_{g}, g₉) of the weighing means (12, 59) is embodied as weighing element (61) which can generate a signal representative of a weight (G_{g}, g_{g}) of a weighing means (59).

13. Conveying device (2) according to claim 12, characterized in that a sensor (50) is arranged on and/or in the axle (26) which can generate a signal representative of the deflection of the axle (26).

14. Storage facility (1), in particular a storage rack (1), having at least one storage location (3), at least one introduction region (9) connected to the storage location (3), and at least one conveying device (2) which can be moved back and forth between the storage location (3) and the introduction region (9), characterized by a conveying device according to one of claims 9 to 13.
